(19) United States
(12) Patent Application Publication
(10) Pub. No.: US 2005/0179186 A1
(43) Pub. Date: Aug. 18, 2005

(54) Reversible locking device on a structure of a connector with adjustable positioning

(76) Inventors: Michel Genot, Bletterans (FR); Alain Jacquemin-Verguet, Macornay (FR); Jean-Charles Giboudot, Voiteur (FR); Charles Bigot, Lons Le Saunier (FR)

Correspondence Address: Ralph A. Dowell of DOWELL & DOWELL P.C., 2111 Eisenhower Ave., Suite 406, Alexandria, VA, 22314, US

(21) Appl. No.: 11/033,478

(22) Filed: Jan. 12, 2005

(30) Foreign Application Priority Data
Jan. 12, 2004 (FR) 04 00234

(51) Int. Cl. B25B 1/20

(52) U.S. Cl. 269/37

(57) ABSTRACT

The device according to the invention comprises a rigid body fast with the structure and defining a tapped bore for receiving a rod fast with the connector. This rod is externally threaded in manner complementary to the tapped bore in order to allow the distance between the connector and the structure to be freely adjusted. In order to lock the connector reliably, a rigid ring is mounted around the rod, being both free in axial translation along this rod and linked in rotation with this rod. A rigid bush for reversibly blocking the ring in abutment against the body is movably connected around this body. The invention is particularly applicable to the locking of components inside a vehicle with the fuselage of this vehicle, particularly in an aircraft.

### FIELD Of THE INVENTION

The present invention relates to a device for reversibly locking a connector on a structure and more particularly to a locking/unlocking device which, in an unlocked configuration, allows the adjustment in “tension”, i.e. the adjustment of the distance between the connector and the structure and which, in a locked configuration, definitely sets the adjustment effected.

The invention is generally applicable to domains in which connectors or the like are to be adjustably assembled on a structure or more generally a chassis subsequently subjected to vibrations. This is the case, for example, of the aeronautic domain in which components such as baggage chests are to be connected to the fuselage of an aircraft.

### BACKGROUND OF THE INVENTION

In order to allow adjustment of the distance separating the connector from the structure, while the locking device is in its unlocked configuration, the connector is fast with an externally threaded rod, which is screwed inside a bore tapped in complementary manner, defined in the structure or, most often, in a rigid body integrally connected on the structure. In its locked configuration, the device is in that case intended to prohibit, or in any case prevent as much as possible, the rotation of the connector with respect to the structure in order to avoid modifying the adjustment set previously.

In order to lock the connector on the structure, a first solution consists in forming the bottom of the bore receiving the threaded rod as a conical frustum so that the free end of this rod is wedged inside the conical frustum when it advances inside the bore by screwing. This solution presents numerous drawbacks. Firstly, the mechanical resistance of the locking of the connector on the structure is weak. Moreover, the amplitude of adjustment that can be envisaged is limited by the inclination of the wedging cone. Finally, as soon as the connector is unscrewed, after having been locked a first time, it becomes delicate, and even impossible, to block the end of the rod of the connector in the conical frustum again.

A second solution consists in using a locking device comprising, on the one hand, a hexagonal nut connected around the rigid body fast with the structure and, on the other hand, an arm articulated on the connector about an axis transverse with respect to the longitudinal direction of the threaded rod to be introduced in the bore of the rigid body. This arm is provided at its free end with a flexible, substantially hexagonal bush, complementary of the nut connected to the rigid body. This bush is open on a part of its periphery so as to be able to be radially deformed in order, when the articulated arm is pivoted towards the rigid body, to cover the nut, thus blocking the connector in rotation with respect to the rigid body. However, although this device presents the advantage of being reversible, it does not guarantee a very efficient locking since, by reason of the flexibility of the locking bush, the application of a considerable torque on the connector easily provokes the deformation of the bush and consequently allows the rotation of the connector with respect to the structure over at least a sixth of turn. Moreover, the locking bush of this device is difficult to manipulate.

Moreover, Patent GB-A-M26012 discloses an assembly for locking two tubes on each other, one of the tubes defining a tapped bore for receiving the threaded end of the other tube. This locking assembly comprises, around the ends of the tubes screwed in each other, a ring and a bush adapted to be screwed on each other until this ring and this bush tighten on joined flanges respectively fast with the two tubes. As long as the screwing between the ring and the bush is incomplete, these elements remain free to rotate about their associated tube since respective radial clearances exist between these elements and the tubes. This results in that the locking of the two tubes can only be envisaged if the screwing of these tubes in each other is sufficient for the flanges of the tubes to be firmly joined against each other. If a free space remains between these flanges, the locking obtained by the screwing of the ring and the bush on each other subsequently does not prevent modifying the relative positions of the two tubes by screwing. In other words, the locking assembly proposed in GB-A-M26012 does not come under the domain of the invention which allows a free adjustment “in tension” between the structure and the connector to be locked.

It is an object of the present invention to propose a novel reversible locking device which guarantees an efficient locking of the connector with respect to the structure, even when this connector is stressed under a considerable torque, while being easy and rapid to maneuver.

### SUMMARY OF THE INVENTION

To that end, the invention relates to a device for reversibly locking a connector on a structure, comprising a rigid body fast with the structure and defining a tapped bore for receiving a rod fast with the connector and provided with an outer thread complementary of the tapped bore, the connector being locked by the device in a position, with respect to the structure, which, before locking, is freely adjusted by screwing the rod in the bore of the body, characterized in that it comprises, on the one hand, a ring mounted around the rod which is both free in axial translation along this rod and linked in rotation with this rod and, on the other hand, a bush for reversibly blocking the ring in abutment against the body, movably connected around the body.

Once the position of the connector is adjusted with respect to the rigid body, by screwing its rod in the bore of the body, the bush is displaced in order to block, particularly axially, the ring which is initially free to move in translation with respect to the rod, this provoking locking of the devices The rigidity of the components of the device ensures a good mechanical resistance in locked configuration. Moreover, the device may be manipulated in one hand by successively maneuvering the ring and the bush.

According to other advantageous characteristics of this device, taken separately or in any technically possible combinations:
The bush is provided with means for axially tightening the ring against the body.
The tightening means comprise a tapping adapted to cooperate with a complementary thread of the ring.
The directions of the outer thread of the rod and of the thread of the ring are opposite.
It comprises a supple annular safety element interposed between the ring and the body, adapted to axially retain the ring with respect to the body at the beginning of the application of an effort of tightening by the bush.
It comprises a supple annular safety element interposed between the bush and the body, adapted to axially retain the bush with respect to the body when the ring is tightened by the bush.
It comprises means for indicating that an effort of tightening of predetermined value is applied by the bush on the ring.
The means comprise a stud radially mobile with respect to the bush and an elastic compression means radially interposed between the stud and the ring, a through hole, which allows the passage of the stud, being made in a zone of the bush located radially plumb with respect to the stud when the tightening effort applied by the bush attains said predetermined value.
The body bears an axial stop surface for the bush.
The ring is at least partly split axially.

### BRIEF DESCRIPTION OF THE DRAWINGS

The invention will be more readily understood on reading the following description given solely by way of example and made with reference to the accompanying drawings, in which:

FIG. 1 is a view in perspective of a locking device according to the invention, in an unlocked configuration.

FIG. 2 is a longitudinal section along the plane of section II indicated in FIG. 1, the device being in a locked configuration.

FIG. 3 is a longitudinal section along plane III-III indicated in FIG. 2; and

FIG. 4 is a view on a larger scale of detail IV of FIG. 2.

### DESCRIPTION OF PREFERRED EMBODIMENT

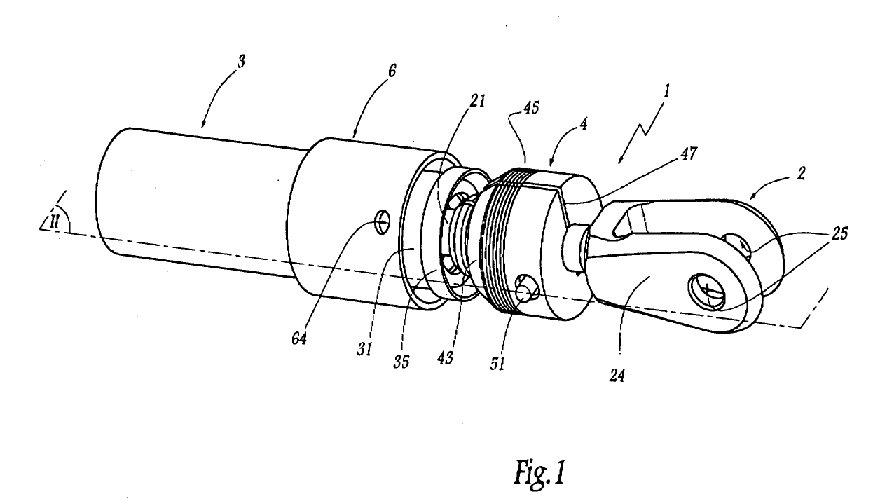

Referring now to the drawings, the locking/unlocking device 1 shown in FIGS. 1 to 4 is adapted to mechanically lock a connector 2 on a tubular structure 3 of longitudinal axis X-X. By way of example, the structure 3 constitutes a part of the chassis of an assembly of baggage chests embarked on board an aircraft and the connector 2 is intended to be connected to the fuselage of the aircraft.

In the following description, the term “front” will, for convenience, designate a direction directed towards the structure 3, i.e. towards the left in FIGS. 1 to 4, while the term “rear” will designate the opposite direction.

The connector 2 comprises a front part 21 in the form of a solid cylindrical rod, whose longitudinal axis merges with axis X-X in the Figures. The front part of this rod 21 is provided with an outer thread 22. A rectilinear groove 23 is hollowed out over the whole length of the rod.

At its rear end, the rod 21 is fast with a stirrup member 24 of which the arms extend substantially in directions parallel to axis X-X and are pierced right through with orifices 25 aligned in a direction substantially perpendicular to axis X-X. These orifices 25 are intended to receive a rod (not shown) for connection of the connector 2 with a structural component (not shown), for example part of the fuselage of the aircraft which, when it is used, is subjected to mechanical stresses and/or to vibrations inducing on the connector 2 a torque about axis X-X.

With a view to linking the connector 2 to the tubular structure 3, the latter is equipped with a substantially tubular rigid body 31 of axis X-X. This body is fixedly connected to the structure 3, being for example force-fitted in the rear end of the structure. In a variant (not shown), the body 31 is directly integral with the structure.

The body 31 is traversed right through along axis X-X by an inner bore 32 presenting a tapping complementary to the outer thread 22 of the rod 21. In this way, the rod of the connector 2 is able to be screwed in the bore 32 so as to adjust the axial distance between the rigid body 31 and the stirrup member 24, i.e. to adjust the structure and the connector “in tension”.

To the rear of the bore 32, the body 31 presents a tubular zone 33 whose internal diameter is greater than the diameter of the bore, thus forming an inner radial shoulder 34. The rear end of this zone 33 is externally constituted by a flange 35 which projects radially from the rest of the outer surface of the body 31, forming an outer radial shoulder 36. The inner surface 37 of the flange 35 is of truncated shape, convergent in the direction of axis X-X towards the front.

The device 1 also comprises a substantially tubular, rigid ring 4, for example made of metal. This ring may be threaded around the rod 21. At the level of the inner bore of the ring, there is provided a drive fluting 41 extending over the whole length of the ring and substantially complementary of the groove 23 hollowed out on the surface of the rod 21. In this way, when the ring 4 is mounted on the rod 21, it is linked in rotation with the rod, while remaining free in axial translation along this rod.

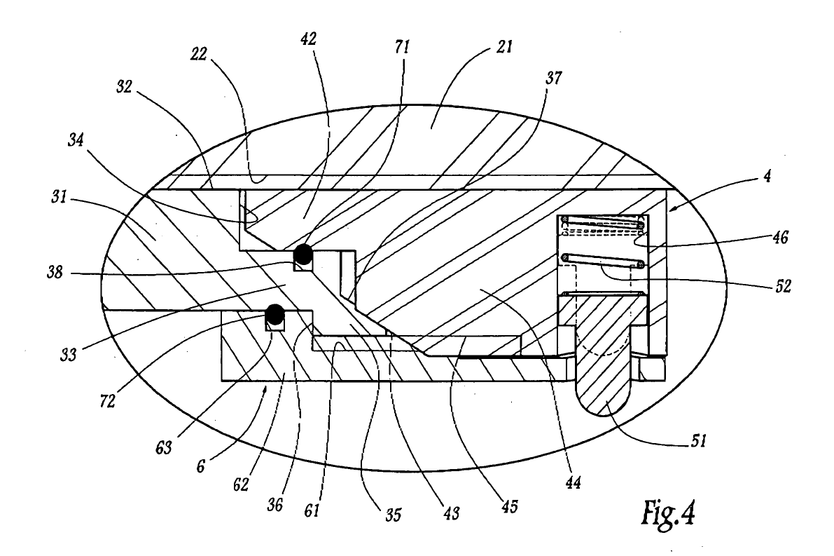

As shown in greater detail in FIG. 4, the ring 4 is successively constituted:
by a front part 42, which is essentially cylindrical with circular base, whose external diameter is substantially equal to the internal diameter of the rear part 33 of the body 31, the front end of this part 42 being shaped in truncated manner, convergent in the direction of axis X-X, towards the front, in order to facilitate the introduction of the ring 4 inside the zone 33.
by an intermediate part of truncated shape convergent in the direction of axis X-x, towards the front, the outer truncated surface of this intermediate part being referenced 43; and
by a rear part 44 which is essentially cylindrical with circular base, provided at the front with an outer thread 44 of which the direction of threading is, for reasons; explained hereinbelow, opposite the direction of the thread 22 of the rod 21.

In the rear part 44 of the ring 4 there is hollowed out a substantially cylindrical radial housing 46 inside which are disposed a stud 51 and a compression spring 52 radially interposed between the base of the stud and the bottom of the housing.

The ring 4 is axially split over the whole of its length, as shown in FIG. 3 which corresponds to the plane of section passing through the corresponding slot 47.

The device further comprises a substantially tubular, rigid bush 6, for example made of metal, movably connected around the body 31 in substantially coaxial manner with respect to the bore 32. In its running part, the bush 6 presents an internal diameter substantially equal to the external diameter of the end flange 35 and is internally provided with a tapping 61 substantially complementary of the thread 45 of the ring 4. At the front of this tapping 61, the bush 6 is provided with an end heel 62 extending radially towards the outside and whose internal diameter is substantially equal to the external diameter of the tubular body 31.

Finally, the device 1 comprises two supple annular elements, or snap rings 71 and 72 respectively housed in a groove 38 hollowed out in the rear part 33 of the body 31, from its inner face, and in a groove 63 hollowed out in the end heel 62 of the bush 6, from its inner face.

The device 1 functions as follows:

In a first step, the device 1 is in an unlocked configuration as shown in FIG. 1. In this configuration, the bush 6 is located at the front of the rear end flange 35 of the body 31 and the ring 4 is freely movable in axial translation between the rear end of the groove 23 and the body 31, the rod 21 being engaged inside the bore 32. In this unlocked configuration, the stud 51 partially projects, under the action of the spring 52, from the outer surface of the rear part 44 of the ring 4. Means (not shown) are provided to avoid this stud 51 being totally disengaged from the housing 46.

The connector 2 is then freely screwed and/or unscrewed in the body 31 so as to adjust the axial distance between these elements.

Once this adjustment is effected, the user uses one hand in particular to slide the ring 4 axially towards the front until its truncated surface 43 comes substantially in contact with the truncated inner surface 37 of the rear end flange 35 of the body 31. When these surfaces 37 and 43 are in contact, to within a functional clearance, the snap ring 71 clips inside an annular groove hollowed out on the outer surface of the front part 42 of the ring. The ring is then axially retained with respect to the body 31, the user having to overcome the resistance of the snap ring 71 if he desires to disengage the ring towards the rear.

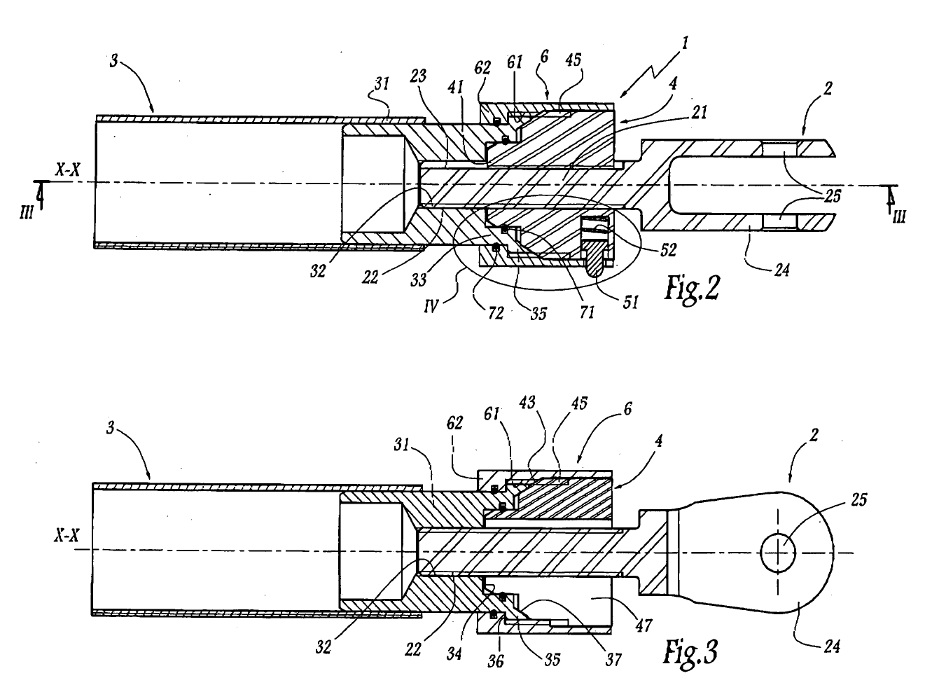

In order to effect an efficient blocking, particularly in axial translation, of the ring 4 with respect to the tubular body 31, the rigid bush 6 is used. More precisely, the bush passes from its position of FIG. 1 to its position of FIGS. 2 to 4, being slid axially towards the rear until its inner tapping 61 comes into axial abutment against the outer thread 45 of the ring.

In order not to prevent the bush 6 from sliding freely towards the rear, the user pushes the stud 51 radially inside its housing 46, compressing the spring 52. In this configuration, the stud and the spring are represented in dotted lines in FIG. 4.

The user then screws the bush 6 on the ring 4, provoking tightening of the latter against the body 31, the truncated surface 43 being pressed against the truncated surface 37. When the screwing of the bush 6 around the ring 4 starts, the snap ring 71 retains the ring axially and avoids it being pushed towards the rear.

Insofar as the directions of the threads 22 of the connector 2 and 45 of the ring 4 are opposite, the screwing of the bush 6 does not bring about rotation of the connector 2 inside the bore 32, which guarantees that the adjustment of the connector 2/structure 3 assembly is not modified in length.

During tightening of the ring, the edges of the slot 47 tend to close on one another so as to compensate the clearances of the device 1.

Tightening of the ring 4 by the bush 6 against the body 31 continues until the heel 62 comes into axial abutment against the outer shoulder 36 of the body 31, in that case provoking clipping of the snap ring 72 inside an annular groove hollowed out on the outer surface of the body 31. The device 1 is then in its locked configuration of FIGS. 2 to 4.

The arrival of the bush 6 at the end of screwing on the ring 4 also provokes the radial alignment of the housing 46 with a radial orifice 64 traversing the bush 6 in its rear part. The cross section of this hole 64 being at least greater than the cross section of the stud 51, the latter is then deployed radially towards the outside, under the effect of the spring 52, its outer end projecting outwardly of the bush 6. In its deployed state of FIGS. 2 to 4, the stud 51 therefore indicates to the user that the bush 6 is suitably tightened on the ring 4, i.e. that the tightening torque applied by this bush on the ring is sufficient to guarantee the expected locking of the device 1.

In this locked configuration, the ring 4 is immobilized by the bush 6 with respect to the tubular body 31, with the result that, when the connector 2 is subsequently subjected to vibrations or external stresses, any movement of rotation of the connector about axis X-X is prevented.

It will be understood that, for the blocking of the ring 4 by the tightening bush 6 to be as efficient as possible, the cooperation of the thread 45 and of the tapping 61 is essential. To that end, a plurality of independent and cumulative arrangements can be envisaged. Firstly, the direction of the thread 45 may be provided to provoke an even greater tightening of the ring 4 by the bush 6 when the connector 2 is stressed by that of the two envisageable torques which is of greater intensity and/or frequency. Consequently, when this considerable or repetitive torque is applied on the connector 2, the device 1 provokes to some extent a more intense locking. However, the shoulder forms a stop surface corresponding to the maximum axial penetration admissible of the ring 4 in the body 31 in order to avoid damaging the device at the level of its truncated surfaces 37 and 43.

Then, the extent of the surfaces of matter in mesh at the level of the thread 45 and of the tapping 61 may be dimensioned highly, by imposing a relatively small helix angle on this threading/tapping assembly, for example smaller than 30°. Consequently, when the threading 45 is completely in mesh with the tapping 61, the ring 4 and the bush 6 are to some extent buttressed.

Similarly, the number of turns of the thread 45 and of the tapping 61 in mesh influences the resistance of the blocking of the ring 4 by the bush 6.

When the device 1 is in its locking configuration and the user wishes to unlock it, he pushes the stud 51 radially towards the inside, if necessary with the aid of an appropriate tool, this constituting an unlocking maneuver of which the user is necessarily conscious. He then partially unscrews the bush towards the front, having previously to overcome the resistance of the snap ring 72. While the threading 45 is still partially in mesh with the tapping 61, he pushes the bush 6 axially towards the rear, in that case driving the ring 4 axially. The adjustment of the connector 2 with respect to the structure 3 in length may then be modified or the bush 6 continues to be unscrewed until it is totally disengaged from the ring 4.

It will be understood that if, in cross section, the hole 64 is substantially complementary of the outer contour of the stud 51, the cooperation of this stud and this hole, when the device 1 attains its locking configuration, renders the presence of the supple snap ring 72 unnecessary, the user having to overcome the resistance of the spring 62 in order to be able to begin unscrewing the bush 6.

Various arrangements and variants to the locking/unlocking device 1 described hereinbove may, in addition, be envisaged:
the snap rings 71 and 72 may be replaced by any supple annular safety element allowing the respective axial retainings of the ring 4 with respect to the body 31 and of the bush 6 with respect to this body, for example by circlips or elastomeric O-rings.
the ring 4 may be equipped with a plurality of flutings similar to fluting 41 and cooperating with as many grooves hollowed out on the surface of the rod 21.
the drive fluting may have different profiles in cross section, for example rectangular, trapezoidal, flat, incurved, etc . . .
the rear part of the connector 2 is not limited to the stirrup-like form as described hereinabove, but is generally adaptable to any mechanical linking member, for example a ball-and-socket joint; and/or
the geometry of the structure 3 on which the device 1 locks the connector 2 is not necessarily tubular.

1. Device for reversibly locking a connector on a structure, comprising a rigid body fast with the structure and defining a tapped bore for receiving a rod fast with the connector and provided with an outer thread complementary of the tapped bore, the connector being locked by the device in a position, with respect to the structure, which, before locking, is freely adjusted by screwing the rod in the bore of the body,
wherein it comprises, on the one hand, a ring mounted around the rod which is both free in axial translation along this rod and linked in rotation with this rod and, on the other hand, a bush for reversibly blocking the ring in abutment against the body, movably connected around the body.

2. The device of claim 1, wherein the bush is provided with means for axially tightening the ring against the body.

3. The device of claim 2, wherein the tightening means comprise a tapping adapted to cooperate with a complementary thread of the ring.

4. The device of claim 3, wherein the directions of the outer thread of the rod and of the thread of the ring are opposite.

5. The device of claim 2, wherein it comprises a supple annular safety element interposed between the ring and the body, adapted to axially retain the ring with respect to the body at the beginning of the application of an effort of tightening by the bush.

6. The device of claim 2, wherein it comprises a supple annular safety element interposed between the bush and the body, adapted to axially retain the bush with respect to the body when the ring is tightened by the bush.

7. The device of claim 2, wherein it comprises means for indicating that an effort of tightening of predetermined value is applied by the bush on the ring.

8. The device of claim 7, wherein said means comprise a stud radially mobile with respect to the bush and an elastic compression means radially interposed between the stud and the ring, a through hole, which allows the passage of the stud, being made in a zone of the bush located radially plumb with respect to the stud when the tightening effort applied by the bush attains said predetermined value.

9. The device of claim 1, wherein the body bears an axial stop surface for the bush.

10. The device of claim 1, wherein the ring is at least partly split axially.
